(19) United States
(12) Patent Application Publication
(10) Pub. No.: US 2014/0067853 A1
(43) Pub. Date: Mar. 6, 2014

(54) DATA SEARCH METHOD, INFORMATION SYSTEM, AND RECORDING MEDIUM STORING DATA SEARCH PROGRAM

(71) Applicant: FUJITSU LIMITED, Kawasaki-shi (JP)

(72) Inventors: Junichi YAMAZAKI, Mishima (JP); Toshio Takeda, Machida (JP); Youichi Ehara, Hiratsuka (JP)

(73) Assignee: FUJITSU LIMITED, Kawasaki-shi (JP)

(21) Appl. No.: 13/954,044

(22) Filed: Jul. 30, 2013

(30) Foreign Application Priority Data
Aug. 29, 2012 (JP) 2012-189105

(51) Int. Cl. G06F 17/30

(52) U.S. Cl. CPC G06F 17/30424
USPC 707/769

(57) ABSTRACT

A data search method includes: identifying data and a key value associated with the data based on a search request issued to a first database stored in a first storage in which data included in a column of the first database is stored in association with a key value that is associated, in the first database, with the data; and searching for a row associated with the identified key value from a second storage in which the key value in the first database is stored in association with the row that is associated, in the first database, with the key value.

### CROSS-REFERENCE TO RELATED APPLICATION

This application is based upon and claims the benefit of priority from the prior Japanese Patent Application No. 2012-189105 filed on Aug. 29, 2012, the entire contents of which are incorporated herein by reference.

### FIELD

The embodiments discussed herein are related to a data search method, an information system, and a recording medium storing a data search program.

### BACKGROUND

In a key value store (KVS) technique, data is managed in association with a corresponding key. In a distributed KVS system, a KVS database is distributed among a plurality of servers.

In the distributed KVS system, a table in a relational database (RDB) is clustered on a row-by-row basis into a database in a KVS format and stored in a memory of a server of the system. When a key and a table name are specified as search keys by a user, memories of servers are searched, and a search result is returned to the user.

In such a distributed KVS system, search processes and data are distributed among a plurality of servers, and thus a high-speed search process may be achieved even when each server has relatively low performance. Furthermore, when an RDB is converted into a KVS format, it is known that columns of the RDB are concatenated into text strings and stored as keys.

Related arts may be found, for example, in Japanese Laid-open Patent Publication Nos. 2011-8451, 08-36514, and No. 2000-222434.

### SUMMARY

According to an aspect of the invention, a data search method includes: identifying data and a key value associated with the data based on a search request issued to a first database stored in a first storage in which data included in a column of the first database is stored in association with a key value that is associated, in the first database, with the data; and searching for a row associated with the identified key value from a second storage in which the key value in the first database is stored in association with the row that is associated, in the first database, with the key value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a database search apparatus according to a first embodiment;

FIG. 2 is a diagram illustrating an overall configuration of a distributed KVS system according to a second embodiment;

FIG. 3 is a functional block diagram illustrating a functional configuration of each apparatus in a distributed KVS system according to the second embodiment;

FIG. 4 is a diagram illustrating a relationship among an RDB, a first storage unit, and a second storage unit;

FIG. 5 is a flow chart illustrating a flow of a search process performed in a distributed KVS system according to the second embodiment;

FIG. 6 is a process sequence diagram illustrating a flow of a search process performed in a distributed KVS system according to the second embodiment;

FIG. 7 is a process sequence diagram illustrating a flow of a JOIN process performed in a distributed KVS system according to the second embodiment;

FIG. 8 is a diagram illustrating a detailed example of a search process;

FIG. 9 is a diagram illustrating a detailed example of a JOIN process; and

FIG. 10 is a diagram illustrating an example of a hardware configuration.

### DESCRIPTION OF EMBODIMENTS

When data is managed using the KVS system, a reduction in performance of the search process may occur.

For example, when search corresponding to a column search in a RDB is performed in a distributed KVS system, the distributed KVS system is allowed to perform column search only after information clustered from each row of a table of the RDB is extracted. Therefore, performing a search process when the distributed KVS system includes a large amount of information takes time.

Furthermore, in the distributed KVS system, data is distributed among servers using hashes of key values. However, in the method of concatenating text strings of columns of the RDB and storing the result into a key, the search process may not be performed unless the full name of the key value is known, and thus this method is not allowed to be used in the distributed KVS system. Thus, this method has low versatility.

Embodiments of a data search program, a database apparatus, and an information processing system according to the present application are described in detail below, with reference to drawings. The present invention is not limited by the embodiments.

### First Embodiment

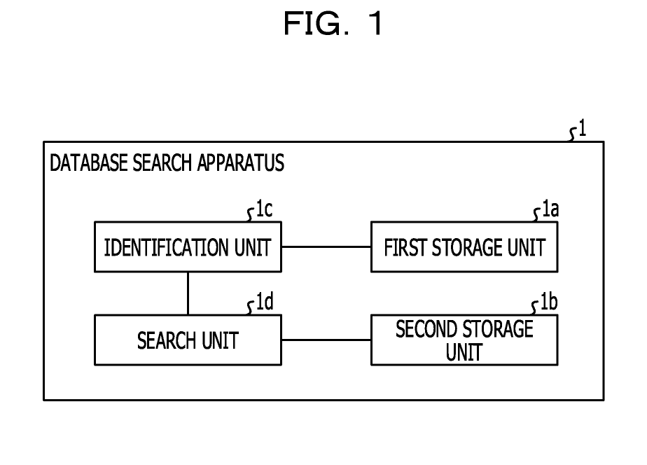

FIG. 1 is a diagram illustrating a database search apparatus according to a first embodiment. The database search apparatus 1 illustrated in FIG. 1 is configured to convert data managed by a relational database (RDB) into a key value store (KVS) database and manage the data in the KVS database. More specifically, the database search apparatus 1 includes a first storage unit 1a, a second storage unit 1b, an identification unit 1c, and a search unit 1d thereby managing RDB data by using KVS.

The first storage unit is stores and associates together data included in a column of the RDB and a key value there associated, in the RDB. The second storage unit 1b stores and associates together a key value in the RDB and a row there associated, in the RDB. The identification unit is identifies data and a key value associated with the data from the first storage unit is in response to a search request issued to the RDB by an application or the like. The search unit 1d searches the second storage unit 1b to get a row associated with the key value identified by the identification unit 1c.

As described above, when managing RDB data by using a KVS the database search apparatus 1 is capable of searching the KVS, in which keys of the RDB are associated with rows of the RDB, by using a value identified from an inverted index in which RDB columns are associated with corresponding keys. Thus the application or the like is able to search for target data using SQL as in the RDB. Therefore, the database search apparatus 1 is capable of performing a column search without extracting all values, which allows for an increase in the processing speed of the data search.

### Second Embodiment

In the first embodiment described above, an example wherein one server manages RDB data by using KVS and performs a data search process was discussed. However, embodiments are not limited to the example described above. For example, a distributed KVS system may be realized so as to be capable of performing a data search process at high speed. Thus, in a second embodiment described below, an example of a distributed KVS system will be discussed.

Overall Configuration

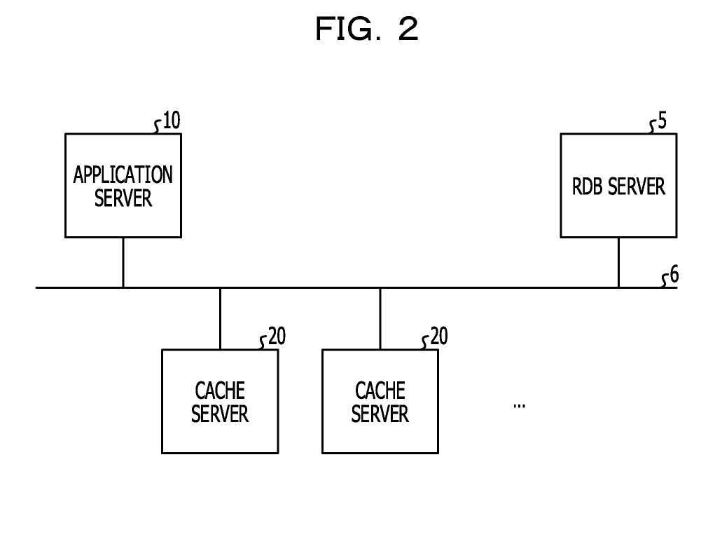

FIG. 2 is a diagram illustrating an overall configuration of the distributed KVS system according to the second embodiment. In this distributed KVS system, as illustrated in FIG. 2, an RDB server 5, an application server 10, and a plurality of cache servers 20 are connected to each other via a network 6. The number of servers or the like illustrated in FIG. 2 is merely an example and is not limiting.

The distributed KVS system according to the second embodiment is configured so that data managed by the RDB server 5 is allowed to be managed by a KVS. KVS data is distributed among the cache servers 20 so that the KVS data given to each of the respective cache servers 20 is resident in a memory thereof. Because distribution of KVS data among the cache servers 20 may be performed using a distribution method based on hash values of keys or other similar known methods, a further description thereof is omitted.

The RDB server 5 is a database server that manages data by using a RDB. The application server 10 is a server apparatus that analyzes an SQL statement issued by an application and searches the cache server 20 for requested data from. Each of the cache servers 20 is a server apparatus configured to manage, by means of a KVS, the data distributed based on the hash values of keys or the like, and the KVS is managed in memory.

In the distributed KVS system configured in the above-described manner, the application server 10 identifies, via an SQL statement issued by an application, a cache server 20 in which data to be retrieved is stored. The application server 10 then transmits a get command to the identified cache server 20 to get particular data.

Functional Configuration

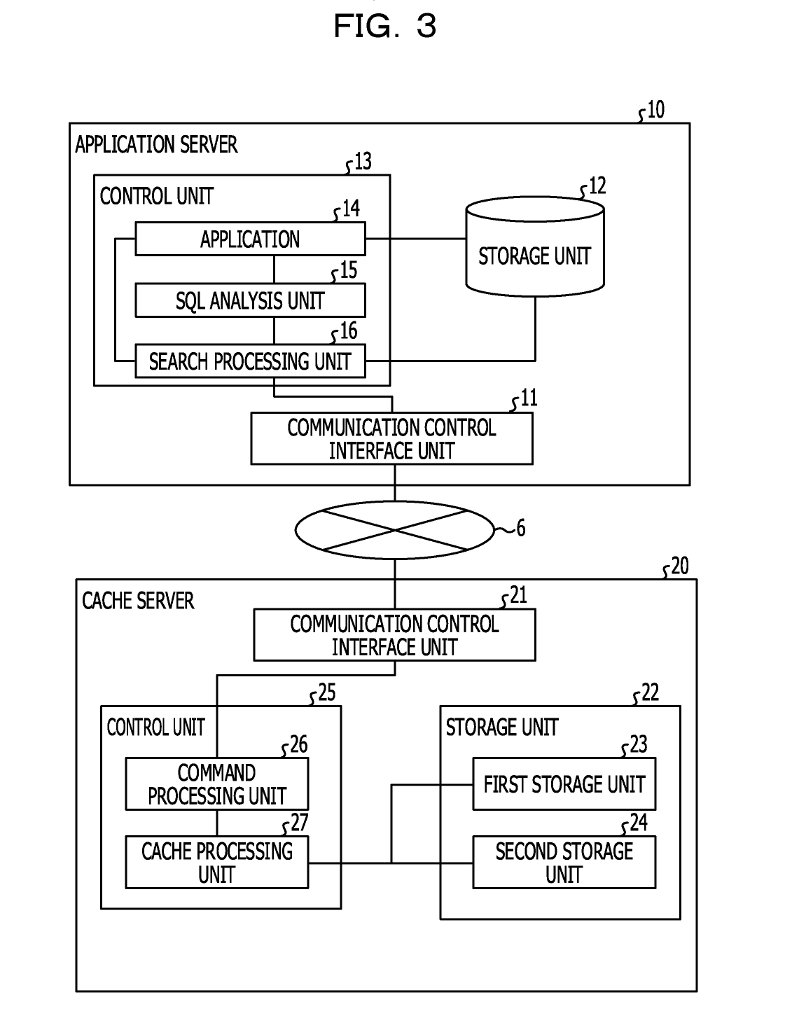

FIG. 3 is a functional block diagram illustrating a functional configuration of each apparatus in a distributed KVS system according to the second embodiment. An RDB server 5 illustrated in FIG. 2 may be configured in a common manner, although a further detailed description thereof is omitted here.

Application Server

As illustrated in FIG. 3, an application server 10 includes a communication interface unit 11, a storage unit 12, and a control unit 13. The storage unit 12 is a storage apparatus such as a hard disk drive. The control unit 13 is an electronic circuit such as a central processing unit (CPU). The configuration of the application server 10 illustrated in FIG. 3 is merely an example, and the application server 10 may be configured in a different manner. For example, the application server 10 may include a display unit such as a display, an input unit such as a mouse, or the like.

The communication interface unit 11 is a processing unit that controls communication with other devices. For example, the communication interface unit 11 transmits a command such as a get command to a cache server 20 and receives a search result from the cache server 20.

The storage unit 12 stores information such as a program executed by the control unit 13 and data to be used by the control unit 13. For example, the storage unit 12 may also have a temporary storage area for storing a result or an intermediate result of a process executed by the application 14 so that the result or the intermediate result is allowed to be used in an operation or the like.

The control unit 13 is a processing unit that includes an application 14, an SQL analysis unit 15, and a search processing unit 16, and is thereby configured to acquire data from the KVS managed by the cache servers 20.

The application 14 is executed by the control unit 13. For example, the application 14 issues to the SQL analysis unit 15 an SQL statement for searching for requested data or for combining data or the like.

The SQL analysis unit 15 is a processing unit that analyzes the SQL statement issued by the application 14 to determine a processing flow. Specifically, the SQL analysis unit 15 generates a processing flow for acquiring requested data from an index table that is an inverted index and a cache table that stores rows of the RDB. For example, the SQL analysis unit 15 processes a flow in which the SQL analysis unit 15 acquires a value from an index table, which is an inverted index, based on a key specified by the SQL statement, and then acquires a value, based on the acquired value, from a cache table in which rows of the RDB are stored.

Furthermore, the SQL analysis unit 15 analyzes the SQL statement used in the RDB and converts the SQL statement into a get command or the like to be used in the KVS. The SQL analysis unit 15 outputs the resultant command to the search processing unit 16.

For example, the SQL analysis unit 15 generates an index name of a table managed by the cache server 20 by combining a FROM clause and a WHERE clause of the issued SQL statement. The SQL analysis unit 15 then outputs the generated index name and the key value specified by the WHERE clause to the search processing unit 16. Furthermore, when the issued SQL statement includes a JOIN clause, the SQL analysis unit 15 generates a table name to be subjected to the JOIN process, which is specified by the JOIN clause, and generates an index name to be subjected to the JOIN process from a column name to be subjected to JOIN process, and the SQL analysis unit 15 outputs the generated table name and generated index name to the search processing unit 16. Upon receiving a search result from the search processing unit 16, the SQL analysis unit 15 returns the search result to the application 14.

An example of a method of producing an index name is described below. The SQL analysis unit 15 combines the table name specified by the FROM clause and the column name specified by the WHERE clause by using “_”. More specifically, the SQL analysis unit 15 generates an index name “table α_B” using a table name “table α” specified by the FROM clause and a column name “B” specified by the WHERE clause.

The search processing unit 16 is a processing unit that issues a data get command to the cache server 20 according to the processing flow given by the SQL analysis unit 15. For example, the search processing unit 16 transmits the get command acquired from the SQL analysis unit 15 to the cache server 20 to get a value retrieved from the index table. The search processing unit 16 then transmits a get command, in which a key is the acquired value, to the cache server 20 thereby acquiring a value retrieved from the cache table. The search processing unit 16 then outputs the value acquired from the cache table to the application 14.

Cache Server

As illustrated in FIG. 3, the cache server 20 includes a communication interface unit 21, a storage unit 22, and a control unit 25. The storage unit 22 may be a storage apparatus such as a memory. The control unit 25 may be an electronic circuit such as a CPU. The configuration of the cache server illustrated in FIG. 3 is merely an example, and the cache server 20 may be configured in a different manner. For example, the cache server 20 may include a display unit such as a display, an input unit such as a mouse, or the like.

The communication interface unit 21 is a processing unit that controls communication with other devices. For example, the communication interface unit 21 receives a command such as a get command from the application server 10 and transmits a search result to the application server 10.

The storage unit 22 includes a first storage unit 23 and a second storage unit 24 and is configured to use a KVS to manage data managed by the RDB server 5 by using a RDB. The storage unit 22 serves as a memory. The first storage unit 23 and the second storage unit 24 may be realized in different storage areas of a single physical memory, or may be realized by two physically different memories.

The first storage unit 23 stores an index table in which data included in a column of the RDB stored in the RDB server 5 is associated with a key value that is associated, in the RDB, with the above-described data. The second storage unit 24 stores a cache table in which a key value in the RDB is associated with a row that is associated with the key value in the RDB.

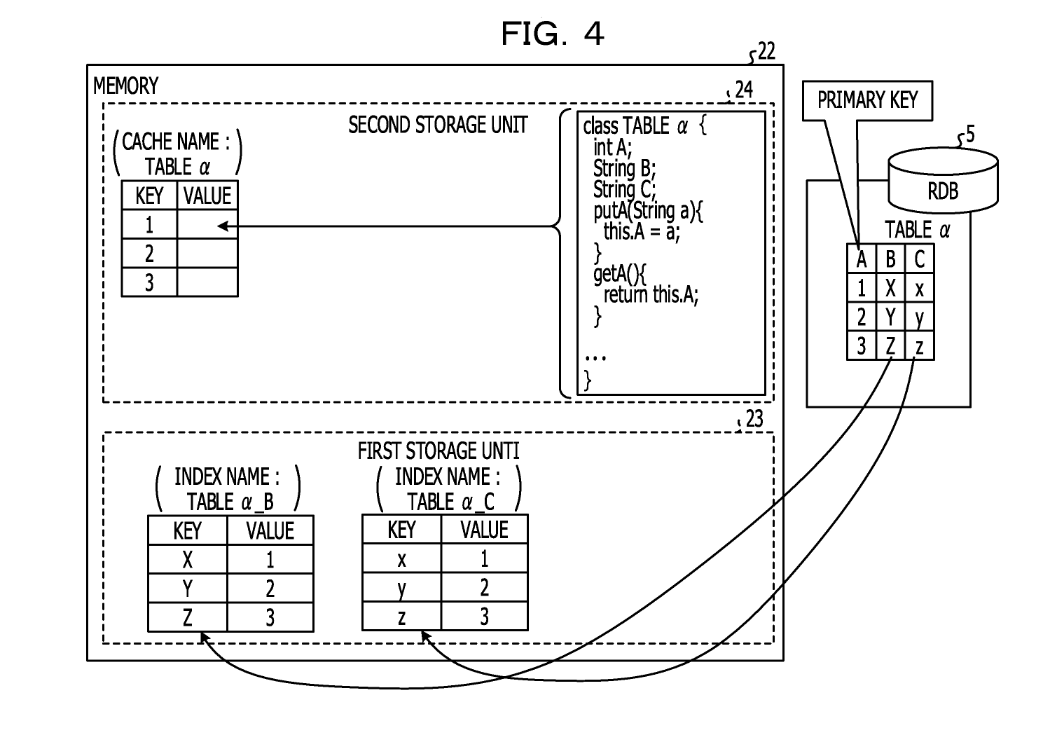

Relationships among the RDB, the first storage unit 23, and the second storage unit 24 are described below. FIG. 4 is a diagram illustrating relationships among the RDB, the first storage unit, and the second storage unit. As illustrated in FIG. 4, the RDB server 5 stores a table α. In table α, primary keys “1”, “2”, and “3” are associated with a column A; data “X”, “Y”, and “Z” are associated with a column B; and data “x”, “y”, and “z” are associated with a column C; whereby these keys and data are associated with each other and are managed. More specifically, the table α manages a primary key “1” associated with data “X” and data “x”, a primary key “2” associated with data “Y” and data “y”, and a primary key “3” associated with data “Z” and data “z”.

In addition, as illustrated in FIG. 4, the first storage unit 23 stores an index table with an index name “table α_B” and an index table with an index name “table α_C”. The “table α_B” is a KVS in which data “X”, “Y”, and “Z” in the column B of the table α in the RDB server 5 are stored as keys, and primary keys “1” “2”, and “3” in the column A of the table α in the RDB are stored as values. That is, the “table α_B” is an inverted index that uses RDB data as keys. In this inverted index, that is the “table α_B”, stores data “X, 1”, “Y, 2”, and “Z, 3” as sets of “key, value”.

Similarly, the “table α_C” is a KVS in which data “x”, “y”, and z” in the column C of the table α in the RDB server 5 are stored as keys, and primary keys “1” “2”, and “3” in the column A of the table α in the RDB are stored as values. That is, the “table α_C” is an inverted index that uses RDB data as keys. In this inverted index, that is, the “table α_C” stores “x, 1”, “y, 2”, and “z, 3” as sets of “key, value”.

Also, as illustrated in FIG. 4, the second storage unit 24 stores a cache table with a cache name “table α”. The cache table “table α” is a KVS in which primary keys “1”, “2”, and “3” in the column A of the table α in the RDB server are stored as keys, and information obtained by turning rows of the table a in the RDB server into objects of a class table α in a Java (registered trademark) Persistence application programming interface (JPA) format is stored as values. More specifically, in the cache table “table α”, a set of data “1, object” is stored as a set of “key, value” where the object is obtained by representing a row corresponding to a primary key (1) of the RDB data as an instance of the class table α. Similarly, in the cache table “table α”, sets of data “2, object” and “3, object” are stored as a set of “key, value” where those objects are obtained by representing a row corresponding to primary keys (2) and (3), respectively, of the RDB data as an instance of the class table α. Note that assigning values for an object may be performed according to a method prescribed in JPA.

Rules for naming each table may be used in common by all cache servers 20 and the application server 10. For example, for a cache table, the same name as the table name used in the RDB may be set. For an index table, “RDB table_RDB column” is set as the name. For the values of the cache table, arrays may be stored instead of an object that is an instance of a given class.

Referring to FIG. 3, the control unit 25 includes a command processing unit 26 and a cache processing unit 27, and is configured to get data from the KVS by using the processing units. The command processing unit 26 is a processing unit that receives commands such as a get command from the application server 10 and outputs commands to the cache processing unit 27. Furthermore, the command processing unit 26 transmits a search result given by the cache processing unit 27 to the application server 10, the issuer of the get command.

The cache processing unit 27 is a processing unit that returns cache data in response to a command received from the command processing unit 26. For example, when the cache processing unit 27 receives a get command with a key “X”, the cache processing unit 27 searches “key” from tables stored in the storage unit 22 and gets a value “2” from the index table “table α_B” and returns it to the application server 10. In addition, when the cache processing unit 27 receives a get command with a key “2”, gets, from the cache table “table α”, an object, an instance of the class table α, for a row corresponding to primary key (2) as a value, and returns the acquired object to the application server 10.

Flow Chart

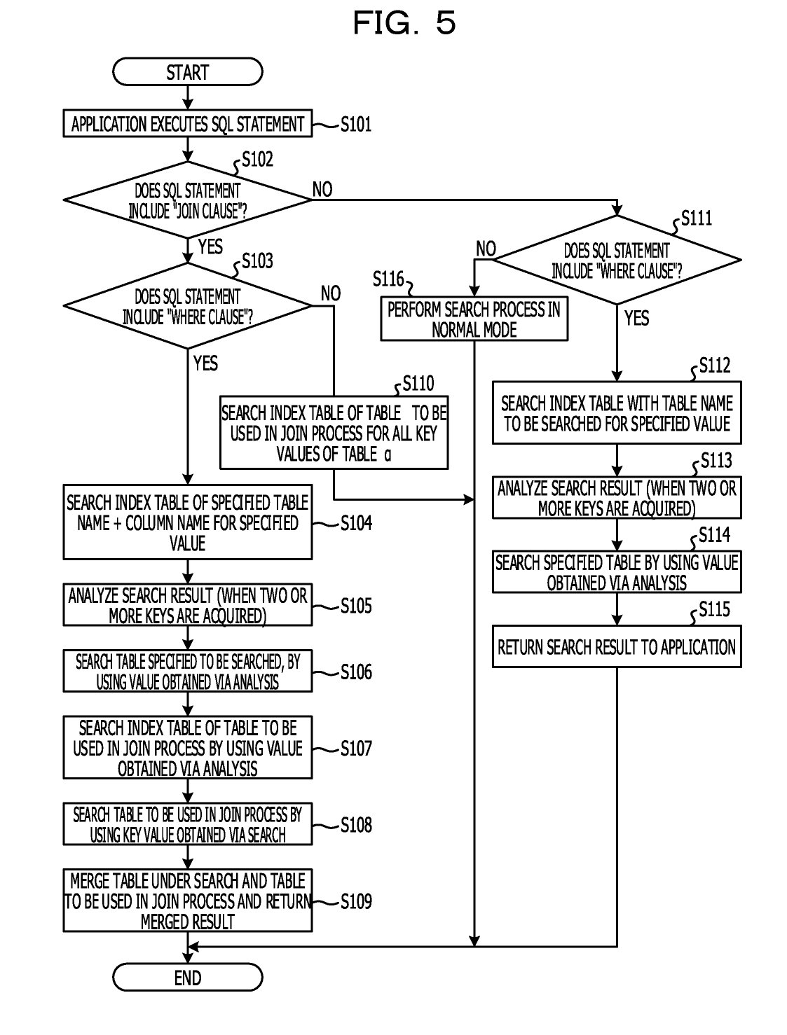

FIG. 5 is a flow chart illustrating the flow of a search process performed in the distributed KVS system according to the second embodiment. In the following description, it is assumed that KVSs have already been produced for two respective RDBs that each include three rows and three columns. That is, a cache table and an index table have been already produced for each of tables α and β.

In the application server 10, as illustrated in FIG. 5, when an application executes an SQL statement (S101), a determination is made as to whether the SQL statement includes a JOIN clause (S102). When the application server 10 determines that the SQL statement includes a JOIN clause (when the determination in S102 is Yes), the application server 10 further determines whether the SQL statement includes a WHERE clause (S103).

When the application server 10 determines that the SQL statement includes a WHERE clause (when the determination in S103 is Yes), the application server 10 searches an index table corresponding to a to-be-searched table (herein after referred to a target table) for a value specified in the SQL statement (S104). For example, the application server 10 searches for a value “Y” in an index table “table α_B”, which is a combination of a target table α and a column name.

The application server 10 then analyzes the search result (S105), and searches the target table using a key value acquired as a result of the analysis (S106). For example, the application server 10 uses as a search key a value “2” obtained as a result of the search using the value “Y” to search the target cache table α. The application server 10 also determines whether two or more keys are acquired, and when two or more keys are acquired, the following process is performed for each key.

Next, the application server 10 searches an index table corresponding to a table to be used in a JOIN process by using the key acquired via the analysis (S107). For example, the application server 10 searches, using the value “Y” as a key, an index table “table β_column name”, which is a combination of a table β and a column name that are to be used in a JOIN process.

Thereafter, using a key value retrieved via that above search, the application server 10 searches the table to be used in a JOIN process (S108). For example, the application server 10 searches the cache table β to be used in a JOIN process using, as a search key, a value “b” retrieved by a search using the value “Y”.

Thereafter, the application server 10 merges a result obtained by searching the target table and a result obtained by searching the table to be used in a JOIN process, and returns the merged result to the application 14 (S109). For example, the application server 10 merges the result obtained by searching the table α and the result obtained by searching the table β.

Conversely, if the application server 10 determined in S103 that the SQL statement does not include a WHERE clause (the determination in S103 is No), the application server 10 performs S110. That is, the application server 10 searches index tables to be used in a JOIN process for all key values of the target table, merges all results, and returns the merged result to the application 14. For example, the application server 10 searches the index table of the table 13 for all keys of the index table of the table α. Using the search result, the application server 10 further searches the cache table of the table β. The application server 10 then merges all search results.

However, if the determination in S102 is that the SQL statement does not include a JOIN clause (the determination in S102 is No), and the determination in S111 is that the SQL statement includes a WHERE clause (the determination in S111 is Yes), the application server 10 executes S112. That is, the application server 10 searches the index table corresponding to the target table by using the value specified in the SQL statement (S112).

The application server 10 then analyzes a search result (S113), and searches the target table by using a key value acquired as a result of the analysis (S114). The application server 10 returns a search result to the application 14 (S115). When it is determined in S111 that the SQL statement does not include a WHERE clause (the determination in S111 is No), the application server 10 performs a search process in a common manner according to the SQL statement (S116).

Sequence of Search Process

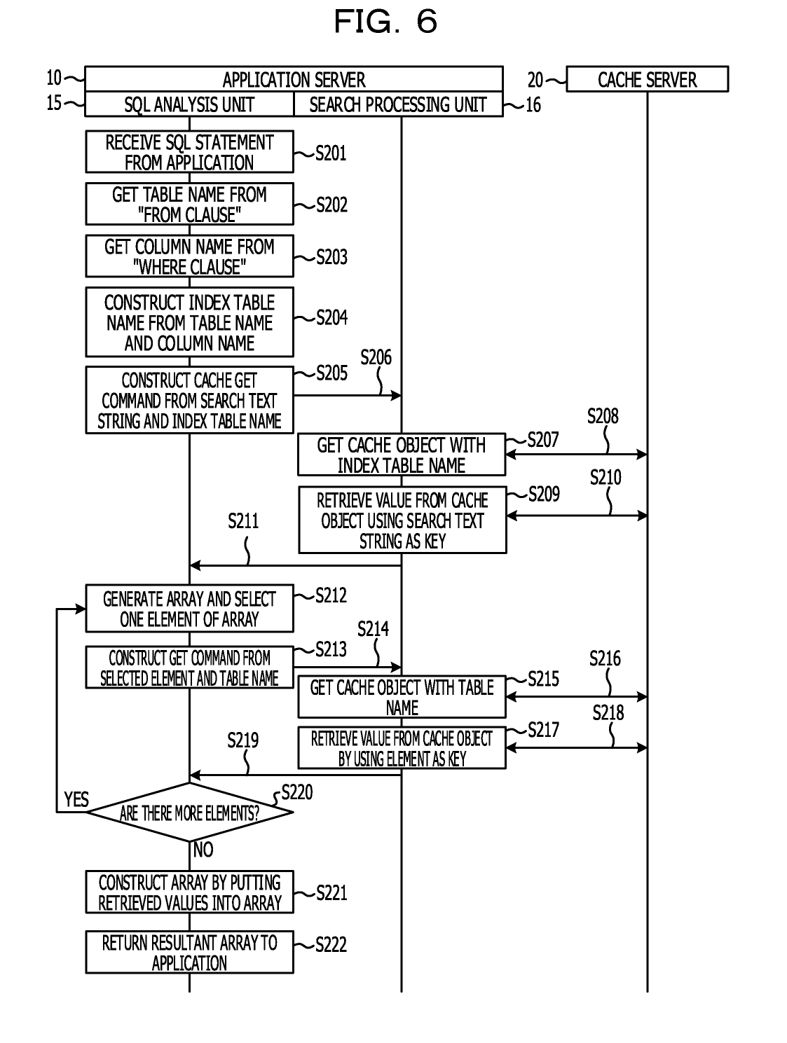

FIG. 6 is a process sequence diagram illustrating the flow of a search process performed in a distributed KVS system according to the second embodiment. In the following description, it is assumed by way of example that a KVS has already been produced for an RDB that includes three rows and three columns. That is, as in FIG. 4, it is assumed that a cache table and an index table have been already produced for a table α. It is further assumed that the application 14 has issued an SQL statement “SELECT * FROM table α WHERE B=‘Y’”.

As illustrated in FIG. 6, the SQL analysis unit 15 of the application server 10 receives an SQL statement from the application 14 (S201), and gets a table name from an SQL table α (S202). The SQL analysis unit 15 then gets a column name from the WHERE clause of the SQL statement (S203). For example, the SQL analysis unit 15 gets a table name “table α” from the FROM clause and a column name “B” from the WHERE clause.

The SQL analysis unit 15 then produces an index table name from the acquired table name and column name (S204). Furthermore, the SQL analysis unit 15 produces a cache get command from the search text string and the index table name and transmits the cache get command to the search processing unit 16 (S205 and S206). For example, the SQL analysis unit 15 transmits an instruction to the search processing unit 16 to search an index table with a table name “table α_B” using, as a search text string, a character string “Y” specified in the WHERE clause in the SQL statement.

The search processing unit 16 gets a cache object having the index table name from the cache server 20 (S207 and S208). For example, the search processing unit 16 establishes a connection with an index table “table α_B” of the cache server 20 according to JPA rules.

Thereafter, the search processing unit 16 gets a value using the search text string as a key from the acquired cache object (S209 and S210). That is, the search processing unit 16 transmits an instruction to the cache server 20 to search the index table specified by the SQL analysis unit 15 to get a value by using, as a key, a search text string “Y” received from the SQL analysis unit 15. The search processing unit 16 gets values of 2 and 4 as a search result from the cache server 20.

The search processing unit 16 then transmits the search result to the SQL analysis unit 15 (S211). The SQL analysis unit 15 generates an array that includes search results as elements, and selects one element (S212). For example, the search processing unit 16 holds retrieved values “2” and “4” in the form of an array and selects “2” from the array.

Thereafter, the SQL analysis unit 15 constructs a cache get command by assembling the selected element and the table name specified by the FROM clause, and transmits the resultant cache get command to the search processing unit 16 (S213 and S214). That is, the SQL analysis unit 15 transmits an instruction to the search processing unit 16 to search the cache table with the table name “table α”, which is specified in the FROM clause in the SQL statement, by using the selected element “2” as a key.

The search processing unit 16 gets a cache object having the cache table name from the cache server 20 (S215 and S216). For example, the search processing unit 16 establishes a connection with the cache table “table α” in the cache server 20 according to JPA rules.

Thereafter, the search processing unit 16 gets a value from the acquired cache object by using the selected element as a key (S217 and S218). That is, the search processing unit 16 transmits an instruction to the cache server 20 to search the cache table specified by the SQL analysis unit 15 to get a value by using, as a key, the element “2” received from the SQL analysis unit 15. The search processing unit 16 gets “class 2” as a search result from the cache server 20.

Thereafter, the search processing unit 16 transmits the search result to the SQL analysis unit 15 (S219). The SQL analysis unit 15 determines whether the array produced in S212 includes an element that has not yet been searched (S220). When it is determined that the array includes an element that has not yet been searched (the determination in S220 is Yes), the SQL analysis unit 15 repeats the process from S212 for the next element. For example, the SQL analysis unit 15 repeats the process from S212 for an element “4” that has not yet been subjected to the search. Here, it is assumed that class 4 is retrieved for the element “4”.

However, if it is determined that the array includes no more elements that have not yet been subjected to the search (the determination in S220 is No), the SQL analysis unit 15 puts search results obtained via the repetition of the process from S212 to S220 into an array (S221), and the SQL analysis unit 15 returns the resultant array to the application 14 (S222). For example, the SQL analysis unit 15 returns “class 2” and “class 4” obtained as final search results to the application 14.

Sequence of JOIN Process

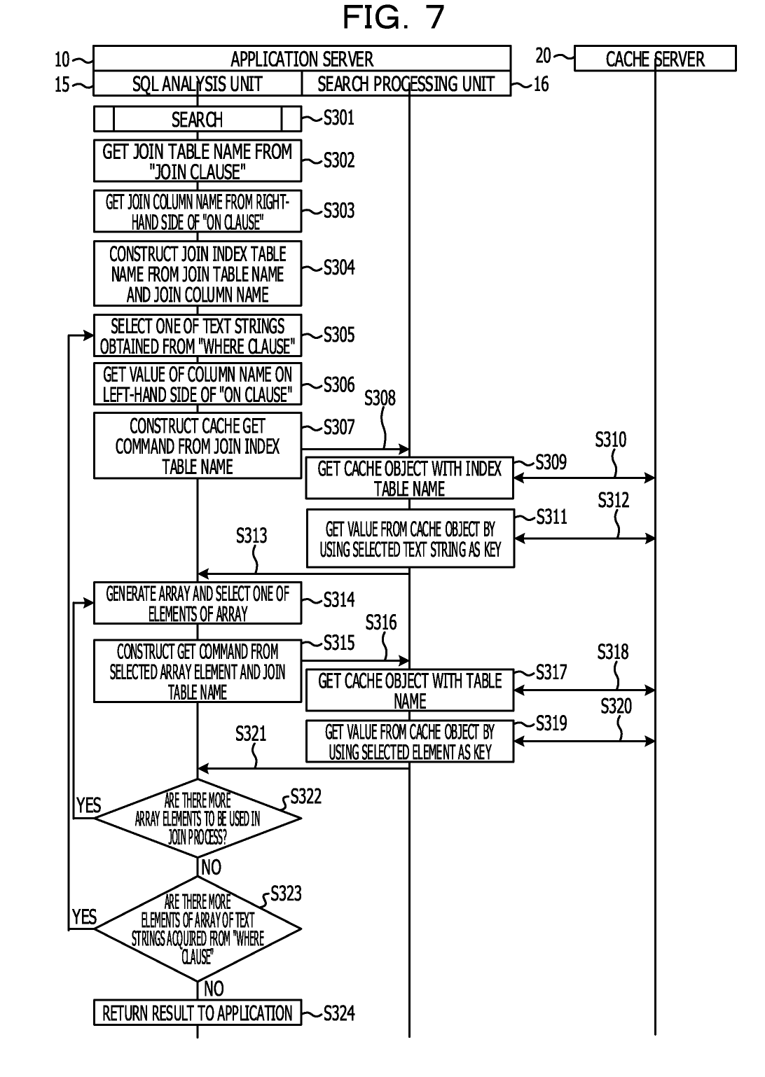

FIG. 7 is a process sequence diagram illustrating a flow of a JOIN process performed in a distributed KVS system according to the second embodiment. In the following description, it is assumed that KVSs have already been produced for two respective RDBs that each include three rows and three columns. That is, a cache table and an index table have already been produced for each of tables α and β. Furthermore, it is assumed that the application 14 issues an SQL statement “SELECT * FROM table α WHERE B=‘Y’ JOIN table β ON table α.B=table β.E”.

As illustrated in FIG. 7, the SQL analysis unit 15 of the application server 10 performs a process similar to that illustrated in FIG. 6 to get data from the target table α (S301).

Thereafter, the SQL analysis unit 15 gets the name of a table to be used in the JOIN process from a JOIN clause in an SQL statement received from the application 14 (S302), and gets a column name from the right-hand side of an ON clause of the SQL statement (S303). For example, the SQL analysis unit 15 gets a table name “table β” from the JOIN clause and a column name “E” from “table β.E” on the right-hand side of the ON clause.

The SQL analysis unit 15 then constructs a JOIN index table name from the JOIN table name and the JOIN column name (S304). For example, the SQL analysis unit 15 produces an index table name “table β_E” from the “table β” acquired in S302 and “E” acquired in S303.

The SQL analysis unit 15 then holds character strings acquired from the WHERE clause of the SQL statement in the form of an array, and selects one of the elements of the array (S305). For example, the SQL analysis unit 15 gets “B=‘Y’” from the WHERE clause and stores it in the array.

Thereafter, the SQL analysis unit 15 gets a column name from the left-hand side of the ON clause of the SQL statement (S306), and produces a cache get command associated with the JOIN index table name (S307 and S308). For example, the SQL analysis unit 15 gets a column name “B” from “table α.B” on the left-hand side of the ON clause in the SQL statement, and identifies “B=‘Y’” corresponding to the column name “B” from the character string acquired from the WHERE clause. The SQL analysis unit 15 then produces a search request to search the index table name “table β_E” produced in S304 by using “Y” as a search key.

The search processing unit 16 gets a cache object having the index table name from the cache server 20 (S309 and S310). For example, the search processing unit 16 establishes a connection with the index table “table β_E” of the cache server 20 according to the JPA rules.

The search processing unit 16 then gets a value using the search text string as a key from the acquired cache object (S311 and S312). That is, the search processing unit 16 transmits an instruction to the cache server 20 to search the index table “table β_E” to get a value by using “Y” as a key. The search processing unit 16 gets “Value=b” as a search result from the cache server 20.

Thereafter, the search processing unit 16 transmits the search result to the SQL analysis unit 15 (S313). The SQL analysis unit 15 generates an array that includes search results as elements, and selects one of elements (S314). For example, the search processing unit 16 stores “b” obtained via the search into the array and selects “b” from the array.

Furthermore, the SQL analysis unit 15 constructs a cache get command from the selected element and the table name specified by the JOIN clause, and transmits the resultant cache get command to the search processing unit 16 (S315 and S316). That is, the SQL analysis unit 15 transmits an instruction to the search processing unit 16 to search the cache table with the table name “table β” specified in the JOIN clause in the SQL statement by using the selected value “b” as a key.

The search processing unit 16 gets a cache object having the cache table name from the cache server 20 (S317 and S318). For example, the search processing unit 16 establishes a connection with the cache table name “table β” in the cache server 20 according to the JPA rules.

The search processing unit 16 then gets a value using the selected element as a key from the acquired cache object (S319 and S320). That is, transmits an instruction to the cache server 20 to search the cache table “table β” to get a value by using element “b” as a key. The search processing unit 16 gets “class b” as a search result from the cache server 20.

The search processing unit 16 then transmits the search result to the SQL analysis unit 15 (S321). The SQL analysis unit 15 determines whether the array produced in S314 includes an element that has not yet been searched (S322). When it is determined that the array includes an element that has not yet been searched (the determination in S322 is Yes), the SQL analysis unit 15 repeats the process from S314 for the next element. In the present example, the array produced in S314 includes only “b” as an element, and thus the SQL analysis unit 15 makes a negative determination in S322.

When it is determined that the array includes no more elements that have not yet been searched (the determination in S322 is No), the SQL analysis unit 15 determines whether the array in which character strings acquired from the WHERE clause in S305 includes an element that has not yet been searched (S323).

When it is determined that the array in which character strings acquired from the WHERE clause in S305 includes an element that has not yet been searched (the determination in S323 is Yes), the SQL analysis unit 15 repeats the process from S305 for the next element. In the present example, the array produced in S305 includes only “B=‘Y’” as an element, and thus the SQL analysis unit 15 makes a negative determination in S323.

When it is determined that the array in which character strings acquired from the WHERE clause in S305 includes no more elements that have not yet been searched (the determination in S323 is No), the SQL analysis unit 15 executes S324. That is, the SQL analysis unit 15 merges the search results acquired in S301 and the search results obtained via the repetition of the process from S302 to S323 and represents the merged values in the form of an array. The SQL analysis unit 15 then returns the resultant array to the application 14. For example, the SQL analysis unit 15 merges “class 2” and “class 4” obtained as final search results in S301 and the search results obtained via the repetition of the process from S302 to S323, and the SQL analysis unit 15 returns the merged values to the application 14.

Specific Example of Search Process

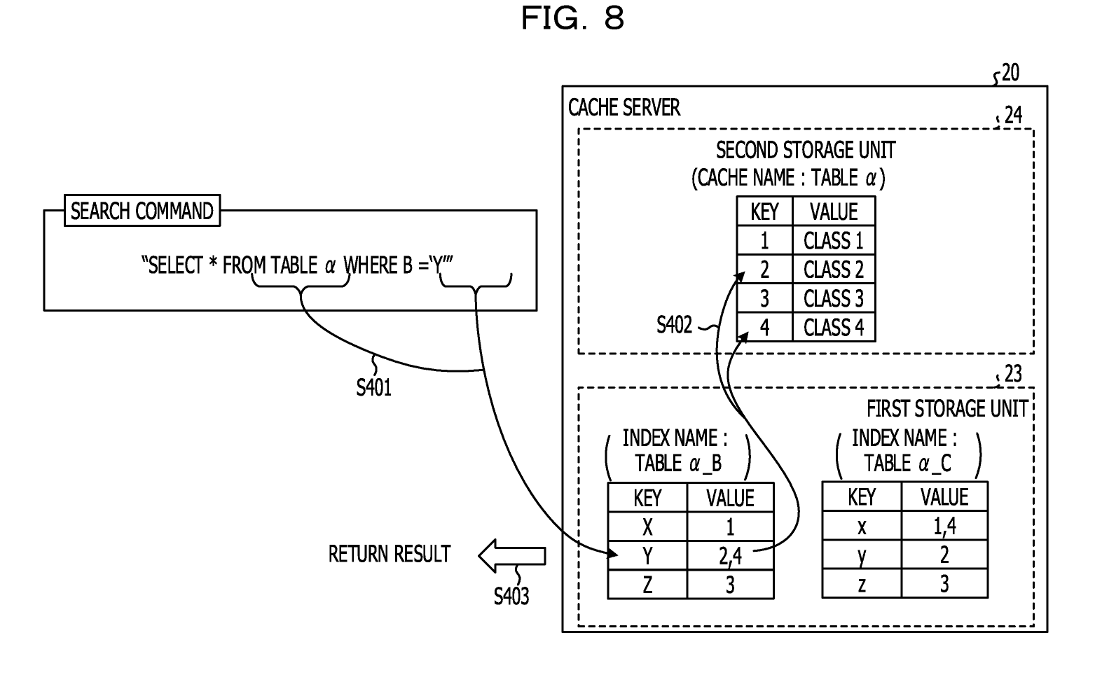

FIG. 8 is a diagram illustrating a specific example of a search process. As illustrated in FIG. 8, the first storage unit 23 of the cache server 20 stores an index table with an index name “table α_B” and an index table with an index name “table α_C”. The “table α_B” is a KVS in which “X”, “Y”, and “Z” are stored as keys, and “1”, “2”, “3”, and “4” are stored as values. That is, “table α_B” stores “X, 1”, “Y, 2, 4”, and “Z, 3” are stored as sets of “key, value”. Conversely, “tableα_C” stores data “x”, “y”, and “z” as keys, and “1”, “2”, “3”, and “4” as values. That is, “table α_C” stores “x, 1, 4”, “y, 2”, and “z, 3” as sets of “key, value”.

On the other hand, as illustrated in FIG. 8, the second storage unit 24 stores a cache table having the cache name “table α”. The “table α” is a KVS in which “1”, “2”, and “3” are stored as keys, and class information is stored as values. For example, in the “table α”, “1, class 1”, “2, class 2”, “3, class 3”, and “4, class 4” are stored as sets of “key, value”.

In this situation, it is assumed that the application 14 issues an SQL statement “SELECT * FROM table α WHERE B=‘Y’”. The application server 10 generates a “table α_B” from the SQL statement by combining “table α” in the FROM clause and “B” in the WHERE clause. The application server 10 then transmits an instruction to the cache server 20 to search an index table with a table name “table α_B” by using, as a search key, the character string “Y” in the WHERE clause (S401).

The application server 10 gets “2” and “4” as a search result from the cache server 20. In response, the application server 10 transmits an instruction to the cache server 20 to search a cache table with the table name “table α” by using “2” and “4” as search keys (S402).

Thereafter, the cache server 20 returns a value “class 2” corresponding to a search key “2” and a value “class 4” corresponding to a search key “4” as search results to the application server 10 (S403).

Specific Example of JOIN Process

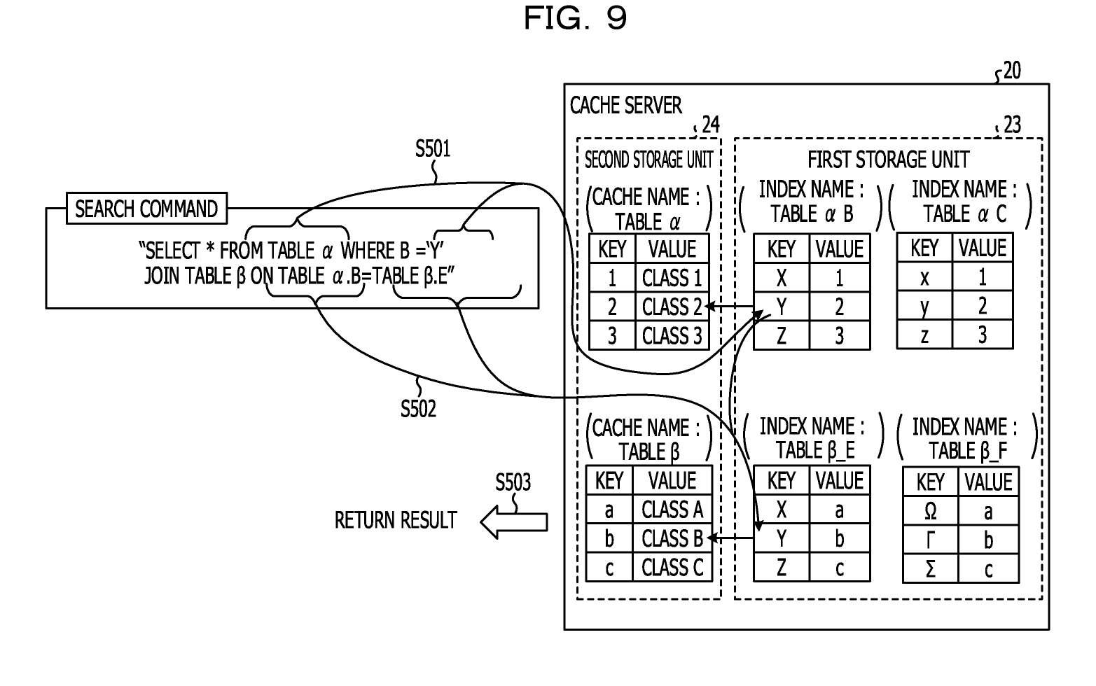

FIG. 9 is a diagram illustrating a specific example of a JOIN process. As illustrated in FIG. 9, the cache server 20 stores a cache table and an index table for each of tables α and β.

More specifically, the first storage unit 23 of the cache server 20 stores, as index tables of a table α, an index table with an index name “table α_β”, and an index table with an index name “table α_C”. The “table α_B” is a KVS in which X, Y, and Z are given as keys and 1, 2, and 3 are given as values. That is, the “table α_B” stores “X, 1”, “Y, 2”, and “Z, 3” as sets of “key, value”. Conversely, “table α_C” is a KVS in which data “x”, “y”, and “z” are stored as keys and “1”, “2”, and “3” are stored as values. That is, the “table α_C” stores “x, 1”, “y, 2”, and “z, 3” as sets of “key, value”.

Furthermore, the first storage unit 23 of the cache server 20 stores an index table with an index name “table β_E” and an index table with an index name “table β_F” as index tables of the table II Note that “table β_E” is a KVS in which “X”, “Y”, and “Z” are stored as keys and “a”, “b”, and “c” are stored as values. That is, “table β_E” stores “X, a”, “Y, b”, and “Z, c” as sets of “key, value”. Similarly, “table β_F” is a KVS in which data “Ω”, “Γ”, and “Σ” are stored as keys and “a”, “b”, and “c” are stored as values. That is, “table β_F” stores “Ω, a”, “Γ, b”, and “Σ, c” as sets of “key, value”.

In addition, as illustrated in FIG. 9, the second storage unit 24 stores a cache table having a cache name “table α”. The “table α” is a KVS in which “1”, “2”, and “3” are stored as keys, and class information is stored as values. More specifically, “table α” stores “1, class 1”, “2, class 2”, and “3, class 3” as sets of “key, value”. The second storage unit 24 also stores a cache table having a cache name “table β”. The “table β” is a KVS in which “a”, “b”, and “c” are stored as keys, and class information is stored as values. More specifically, “table β” stores “a, class A”, “b, class B”, and “c, class C” as sets of “key, value”.

In this situation, it is assumed that the application 14 issues an SQL statement “SELECT * FROM table α WHERE B=‘Y’ JOIN table β ON table α.B=table β.E”.

The application server 10 executes S501. That is, the application server 10 produces “table α_B” from the SQL statement by combining “table α” in the FROM clause and “B” in the WHERE clause. The application server 10 then transmits an instruction to the cache server 20 to search an index table with a table name “table α_B” by using, as a search key, the character string “Y” in the WHERE clause. The application server 10 receives “2” as a search result from the cache server 20. In response, the application server 10 transmits an instruction to the cache server 20 to search the cache table “table α” by using “2” as a search key. Thus, the application server 10 gets a value “class 2” corresponding to the search key “2”.

The application server 10 then executes S502. That is, the application server 10 produces a “table β_E” from the SQL statement by combining “table β” in the JOIN clause and “E” in the ON clause. The application server 10 then transmits an instruction to the cache server 20 to search an index table with a table name “table β_E” by using, as a search key, the character string “Y” in the WHERE clause. The application server 10 then receives “b” as a search result from the cache server 20. The application server 10 then transmits an instruction to the cache server 20 to search the cache table “table β” by using “b” as a search key. Thus, the application server 10 gets a value “class B” corresponding to the search key “b”.

The application server 10 then merges “class 2” obtained as the search result in S501 and the “class B” obtained as the search result in S502, and returns a merged result to the application 14 (S503).

As described above, the application server 10 according to the second embodiment is capable of analyzing the SQL statement and returning only a value (class) corresponding to a search key using an optimum index. Therefore, it is possible to perform a column search without extracting all values. Furthermore, when a database used in an application using RDB is changed into a distributed KVS, SQL statements may be used in the search process without having to change search requests used in SQL into a search request for use with the KVS. Therefore, it is possible to suppress labor costs, costs for modifying the system or the like. That is, it is easy to convert the RDB system into the KVS system.

### Third Embodiment

Embodiments are not limited to examples described above, and embodiments may be realized in further many forms. Thus, some further examples are described below.

System

Some or all of processes that are assumed to be performed automatically in the examples described above may be performed manually. Alternatively, some or all of processes that are assumed to be performed manually in the examples described above may be performed automatically by using a known method. Processing procedures, control procedures, names, information such as various kinds of data, parameters, and the like described above or illustrated in drawings may be modified unless otherwise specified.

In the drawings illustrating constituent elements of respective devices, the drawings illustrate concepts of functions thereof, and physical configurations of the respective devices are not limited to those illustrated in the drawings. That is, specific configurations of the respective apparatuses are not limited to those illustrated in the drawings, and the apparatuses may be divided or combined together. That is, part or all of the apparatuses may be divided or combined physically or functionally depending on various loads or usage situations. Furthermore, part or all of processes and functions performed or realized by the respective apparatuses may be realized by a CPU and a program interpreted and executed by the CPU, or may be realized by wired logic hardware.

Hardware

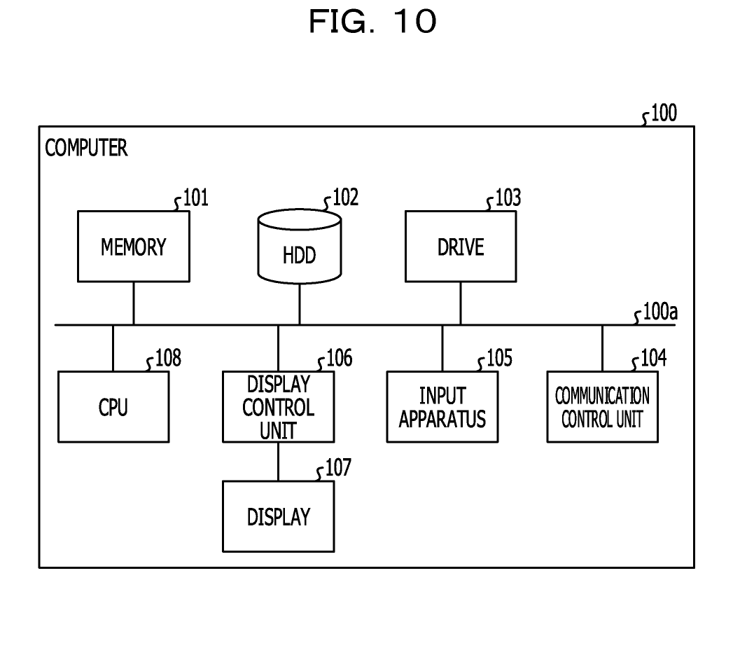

FIG. 10 is a diagram illustrating an example of a hardware configuration. Elements in this hardware configuration correspond to respective apparatuses illustrated in FIG. 2. As illustrated in FIG. 10, a computer 100 includes a memory 101, a hard disk drive (HDD) 102, a drive 103, a communication control unit 104, an input device 105, a display control unit 106, a display 107, and a CPU 108. The units illustrated in FIG. 10 are connected to each other via a bus 100a.

The HDD 102 stores programs or the like that realize the functions illustrated in FIG. 3 or other drawings. Although the HDD 102 is an example of the storage medium, various programs may be stored in another type of computer-readable storage medium such as a read only memory (ROM), a RAM, CD-ROM, or the like, and the computer 100 may read the programs from such a storage medium. The storage medium may be disposed at a remote location, and the computer 100 may acquire programs by accessing the storage medium. Furthermore, the acquired programs may be stored into a storage medium disposed in the computer.

The communication control unit 104 is an interface such as a network interface card (NIC). The input device 105 is a keyboard, a mouse, or the like. The display control unit 106 performs a display process to control the display 107. The display 107 is a device configured to display information.

The CPU 108 reads, from the HDD 102 or the like, programs that are to be executed to realize processes similar to those performed by the respective processing units illustrated in FIG. 2, and the CPU 108 loads the programs into the memory 101 and executes the programs thereby realizing the various functions described above with reference to FIG. 2 or elsewhere. That is, when the computer 100 is the application server 10, the program is executed to realize functions similar to those provided by the respective processing units of the application server 10. More specifically, in this case, the process realized by the program includes a procedure executed to realize a function similar to that provided by the SQL analysis unit 15 and a procedure executed to realize a function similar to that provided by the search processing unit 16.

In addition, when the computer 100 is the cache server 20, the program is executed to realize functions similar to those provided by the respective processing units of the cache server 20. More specifically, in this case, the process realized by the program includes a procedure executed to realize a function similar to that provided by the command processing unit 26 and a procedure executed to realize a function similar to that provided by the cache processing unit 27. That is, the computer 100 may operate as an information processing apparatus that executes a database search method by reading a program and executing it.

When the computer 100 is the cache server 20, the memory 101 stores tables stored in the first storage unit 23 and tables stored in the second storage unit 24.

The computer 100 may read the program from a storage medium via the drive 103, and may execute the read program to realize functions similar to those according to the embodiments described above. The program is not limited to being executed on the computer 100. For example, the program may be executed by another computer or a server, or the program may be executed by a plurality of computers, servers, or the like in a cooperative manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data search method, comprising:
identifying data and a key value associated with the data based on a search request issued to a first database stored in a first storage in which data included in a column of the first database is stored in association with a key value that is associated, in the first database, with the data; and
searching for a row associated with the identified key value from a second storage in which the key value in the first database is stored in association with the row that is associated, in the first database, with the key value.

2. The data search method according to claim 1, wherein
the first database includes a plurality of third databases,
the first storage stores data included in the column in association with the corresponding key value for each of the third databases,
the second storage stores the key value in association with the corresponding row for each of the third databases,
the identifying includes, when the search request includes a command to merge search results, identifying the data and the corresponding key value from a first storage for each of third databases specified by the search request, and
the searching includes searching for a row associated with the identified key value from the second storage for each of third databases specified by the search request, and merging rows retrieved via the searching.

3. The data search method according to claim 1, wherein
the second storage stores, in association with a key value in the first database, object information for a class for a row associated with the key value, and
the searching includes searching for the object information associated with the identified key value from the second storage, and returning a search result to the issuer of the search request.

4. The data search method according to claim 1, wherein the second storage stores, in association with a key value in the first database, array information in which data values in a row associated with the key value are put in the form of an array, and
the searching includes searching for the array information associated with the identified key value from the second storage, and returning a search result to the issuer of the search request.

5. An information system, comprising:
a first storage configured to store data included in a column of a first database in association with a key value associated, in the first database, with the data;
a second storage configured to store the key value of the first database and a row associated, in the first database, with the key value such that the key value and the row are associated with each other; and
a processor coupled to a memory, and configured to:
identify data stored in the first storage and a key value associated with the data from a search request issued to the first database, and
search for a row associated with the identified key value from the second storage.

6. The information system according to claim 5, wherein
the first storage and the second storage are included in a first server apparatus, and
the processor is included in a second server apparatus.

7. The information system according to claim 5, wherein
the first database includes a plurality of third databases,
the first storage stores data included in the column in association with the corresponding key value for each of the third databases,
the second storage stores the key value in association with the corresponding row for each of the third databases, and
the processor is configured to:
identify the data and the corresponding key value from a first storage for each of third databases specified by the search request when the search request includes a command to merge search results,
search for a row associated with the identified key value from the second storage for each of third databases specified by the search request, and
merging rows retrieved via the searching.

8. The information system according to claim 5, wherein
the second storage stores, in association with a key value in the first database, object information for a class for a row associated with the key value, and
the processor is configured to:
search for the object information associated with the identified key value from the second storage, and
return a search result to the issuer of the search request.

9. The information system according to claim 5, wherein
the second storage stores, in association with a key value in the first database, array information in which data values in a row associated with the key value are put in the form of an array, and
the processor is configured to:
search for the array information associated with the identified key value from the second storage, and
return a search result to the issuer of the search request.

10. A computer-readable recording medium storing a data search program configured to control a computer to perform a process, the process comprising:
identifying data and a key value associated with the data based on a search request issued to a first database stored in a first storage in which data included in a column of the first database is stored in association with a key value that is associated, in the first database, with the data; and
searching for a row associated with the identified key value from a second storage in which the key value in the first database is stored in association with the row that is associated, in the first database, with the key value.
